(19) United States
(12) Patent Application Publication
(10) Pub. No.: US 2026/0073492 A1
(43) Pub. Date: Mar. 12, 2026

(54) Spectrum Preservation in Failed Hyperspectral Detector Correction

(71) Applicant: Raytheon Company, Tewksbury, MA (US)

(72) Inventors: Stephen J. RAIF, Nevada, TX (US); Thomas G. RIBARDO, JR., Garland, TX (US)

(21) Appl. No.: 18/810,143

(22) Filed: Aug. 20, 2024

(51) Int. Cl. G06T 5/77; G06T 7/00

(52) U.S. Cl. CPC G06T 5/77; G06T 7/0002; G06T 2207/30168

(57) ABSTRACT

Systems, devices, methods, and computer-readable media for improved hyperspectral images are provided. A method includes determining first pixel data of a first frequency band of frequency bands of a pixel of a hyperspectral image corresponds to a failed detector, determining a neighboring pixel of neighboring pixels of the pixel that has a corresponding first spectral profile (i) most similar to a second spectral profile of the pixel and (ii) corresponds to a non-failed detector, determining second pixel data from the first spectral profile, and replacing the first pixel data with second pixel data in the second spectral profile.

### GOVERNMENT RIGHTS

This invention was made with government support under a government contract awarded by a Federal agency. The government has certain rights in the invention.

### TECHNICAL FIELD

Embodiments regard replacing radiance values and corresponding angles with values that preserve spectrum in a hyperspectral image.

### BACKGROUND

Hyperspectral focal plane arrays have tens to hundreds of thousands of spectrum detectors. Several of these detectors will typically be “failed” or “bad”, meaning that their spectral response is inconsistent and therefore unreliable.

Data from failed detectors may or may not manifest as visible streaks in an output image product. However, data from failed detectors always show up in downstream automated analytics such as anomaly detection (e.g., a Reed-Xiaoli detector (RX) algorithm) or spectral search (e.g., an adaptive cosine estimation (ACE) algorithm), resulting in false alarms.

It is beneficial to correct data from failed detectors both for the visible product (an image) and for downstream processing. Traditional failed detector compensation (FDC) approaches such as one-dimensional (1D) or two-dimensional (2D) interpolation remove most of the effects of the artifact, but there are situations where anomalies remain.

### BRIEF DESCRIPTION OF DRAWINGS

FIG. 1 illustrates, by way of example, a diagram of an embodiment of a technique for FDC that preserves spectral angle.

FIG. 2 illustrates, by way of example, a notional example of a simple hyperspectral image.

FIG. 3 illustrates, by way of example, a notional example of a spectral profile that includes data from a failed detector.

FIG. 4 illustrates, by way of example, a spectral profile that is the result of using a 2D interpolation to fill in band “57 in the spectral profile.

FIG. 5 illustrates, by way of example, a spectral profile that is the ground truth for the pixel corresponding to the failed detector.

FIG. 6 illustrates, by way of example, a diagram of the notional hyperspectral image of FIG. 2 and a plurality of spectral profiles.

FIG. 7 illustrates, by way of example, altering of the spectral profile of FIG. 6 corresponding to the failed detector to generate a spectral profile that is spectrally consistent.

FIG. 8 illustrates, by way of example, a diagram of an embodiment of a method for improved hyperspectral image generation.

FIG. 9 illustrates, by way of example, a block diagram of an embodiment of a machine in the example form of a computer system within which instructions for causing the machine to perform any one or more of the methods or techniques discussed herein may be executed.

### DETAILED DESCRIPTION

The following description and the drawings sufficiently illustrate teachings to enable those skilled in the art to practice them. Other embodiments may incorporate structural, logical, electrical, process, and other changes. Portions and features of some examples may be included in, or substituted for, those of other examples. Teachings set forth in the claims encompass all available equivalents of those claims.

Embodiments may be implemented in one or a combination of hardware, firmware, and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some embodiments may include one or more processors and may be configured with instructions stored on a computer-readable storage device.

In hyperspectral imaging, photons across a set of spectral bins in the across a portion of the electromagnetic spectrum are collected and processed. The goal of hyperspectral imaging is to obtain the spectrum for each spatial pixel in the image of a scene. The spectrum can be used to identify objects, identify materials, or detect processes present in the hyperspectral field of view. There are three general types of spectral imagers. There are push broom scanners and whisk broom scanners (spatial scanning), which read images over time; band sequential scanners (spectral scanning), which acquire images of an area at different wavelengths; and snapshot hyperspectral imagers, which uses a staring array to generate an image in an instant.

The human eye sees color of visible light in mostly three bands (long wavelengths, perceived as red; medium wavelengths, perceived as green; and short wavelengths, perceived as blue). Hyperspectral imaging divides the spectrum into many more frequency bands. This technique of dividing images into more frequency bands can be extended beyond the visible. In hyperspectral imaging, the recorded spectra have fine wavelength resolution and cover a wide range of wavelengths. Hyperspectral imaging measures continuous spectral bands, as opposed to multiband imaging which measures spaced spectral bands.

Engineers build hyperspectral sensors and processing systems for applications in astronomy, agriculture, molecular biology, biomedical imaging, geosciences, physics, and surveillance, among others. Hyperspectral sensors look at objects using a portion of the electromagnetic spectrum. Certain objects leave unique ‘fingerprints’ in the electromagnetic spectrum. Known as spectral signatures, these ‘fingerprints’ enable identification of the materials that make up a scanned object. For example, a spectral signature for oil helps geologists find an oil field.

Unfortunately, hyperspectral sensors are prone to failure. Failure can include complete failure (does not operate to detect any frequencies) or partial failure (does not operate to detect a portion of the spectrum with consistency). A failed detector can be detected using pre or post-deployment testing, and data from that failed detector is typically replaced during processing in a step known as failed detector correction (FDC).

If a pixel corresponding to a failed detector is located near one or more edges of a material, performing FDC using 2D band interpolation mixes different material spectral profiles in the result. The resulting spectral profile will have mostly pure pixels with occasional mixed pixels. This is a problem, because the interpolated pixel value will likely be identified as an anomaly in a downstream anomaly detection or other downstream processing.

Embodiments provide a new technique for failed detector correction (FDC) that better preserves spectral angle and magnitude than prior FDC correction techniques. Embodiments operate by searching regional neighbors for a spectral match. Rather than interpolation between the adjacent detectors (bands or samples), embodiments search a region for a most similar spectrum, and then fills in the failed detector value with a normalized copy of one or more bands of data from the spectral profile demonstrating a most similar spectrum.

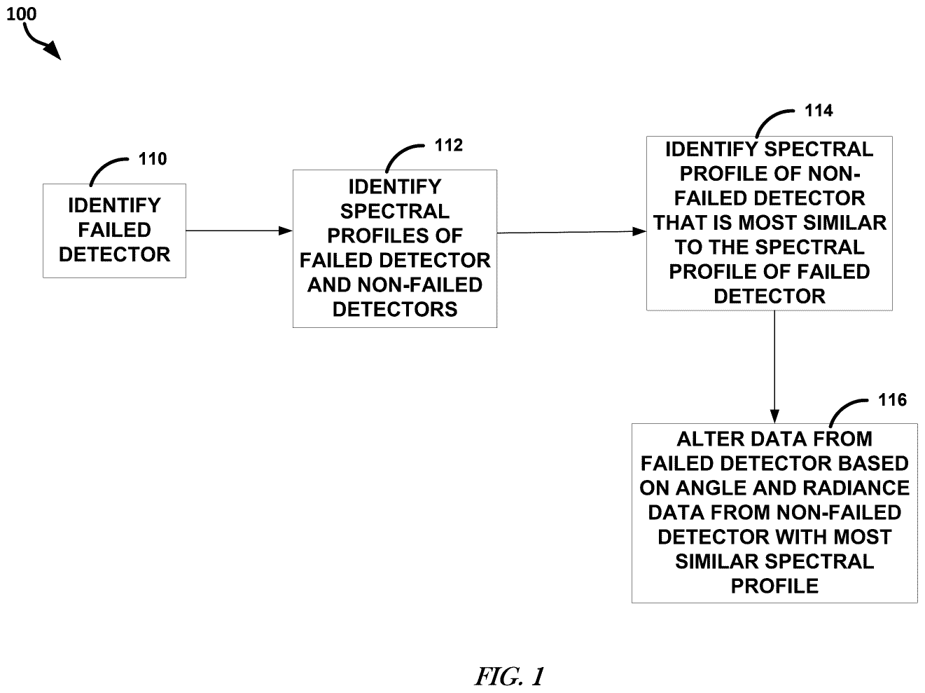

FIG. 1 illustrates, by way of example, a diagram of an embodiment of a technique 100 for FDC that preserves spectral angle. The technique 100 as illustrated includes identifying a failed detector at operation 110. The operation 110 can include identifying an anomalous value provided by a detector of an FPA. Each detector that provides an anomalous value can be flagged as associated with a failed detector.

At operation 112, a spectrum of the pixel containing the failed detector can be identified or generated. The spectrum can include a vector that has a number of entries equal to the number of bands detected by the hyperspectral sensor. The entries for the vector can be the spectral radiance (e.g. number of microflicks) detected at each corresponding band. Each anomalous value of the detector can include an entry set to zero microflicks in the vector. A microflick is a unit of spectral radiance. One flick corresponds to a spectral radiance of 1 watt per steradian per square centimeter of surface per micrometer of span in wavelength (W/(sr*cm²*μm)). One microflick is equivalent to 10 kilowatts per steradian per cubic meter (kW/(sr*m³)).

At operation 114, a good pixel (a multi-band spectral profile not having a failure for the spectral band in question) that is most similar to the bad pixel (the multi-band profile containing content from the failed detector) is identified. The operation 114 can include performing a dot product, cross product, distance calculation, or the like based on the spectrum of the bad pixel and respective spectra of good pixels. The good spectra can be within a specified spatial neighborhood of the pixel with the failed detector. The neighborhood can be a predetermined number of spatial pixels around a perimeter of the pixel corresponding to the failed detector. The neighborhood can be specified in terms of a number of closest pixels, a window of pixels with the pixel of the failed detector corresponding to a center pixel in the window, or the like.

At operation 116, the spectrum with the failed detector can be altered by copying the spectral band value from the good spectrum to replace spectral band value corresponding to the failed detector. When copying the spectral band value, the source radiance value can be normalized to match the destination's radiance profile, with the goal of minimizing the spectral angle difference between the source and destination pixel.

Using the technique 100, instead of interpolating neighboring focal plane detectors (either in in the sample direction, the band direction, or both), a larger local region (in both the frame/line/along/time direction and the sample/cross-FPA direction) are searched for a matching spectral angle. As used herein, “spectral angle matching” or “matching spectral angle” means trying to minimize angles between two spectra. This is helpful on the edges/corners of objects, which may have a rare spectrum originating from a mixture of multiple source material signatures, and thus the best matching spectral angle may be on a different line.

Instead of interpolation of radiance values between bands or between samples, the technique 100 alters radiance and angle values based on the radiance values of the most similar spectrum. Using embodiments, one can alter only a single spectral band (to replace only data from the failed detector), a set of spectral bands (to replace a set of bands about the failed detector), or the entire spectral profile.

A spectral vector magnitude (i.e. absolute spectral radiance) of the source and the spectral vector magnitude of the destination can be used to normalize the copied radiance value(s). This results in the destination not only having a valid spectral angle, but also having a valid magnitude. Normalization can be performed based on Equation 1:

$${x}_{b} = {y}_{b} * \sqrt{{Σ ( {x}_{i} )}^{2}} / \sqrt{{Σ ( {y}_{i} )}^{2}} \qquad Equation 1$$

Where x is radiance values of spectral profile with the failed detector, y is radiance values of the best match good spectral profile, b is the band number for the failed detector being populated, and i is any band number in the neighborhood of b, representing a non-failed detector for both the source and destination.

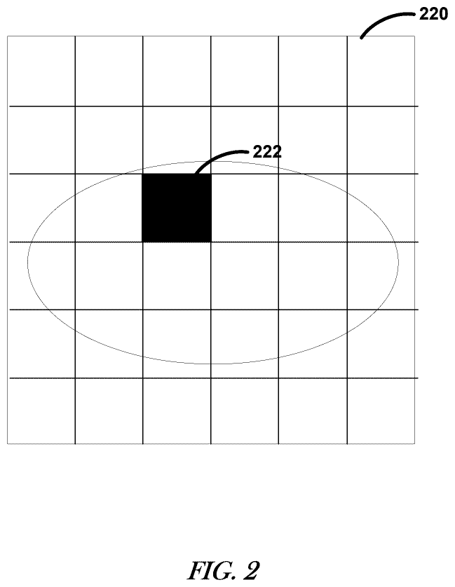

FIG. 2 illustrates, by way of example, a notional example of a simple hyperspectral image 220. The image 220 is generated by an FPA. A pixel 222 corresponds to a detector that has failed. The failed detector is not producing spectral data that is consistent for at least one band. A frequency band is a proper subset of an overall frequency band that spans the entirety of the hyperspectral image.

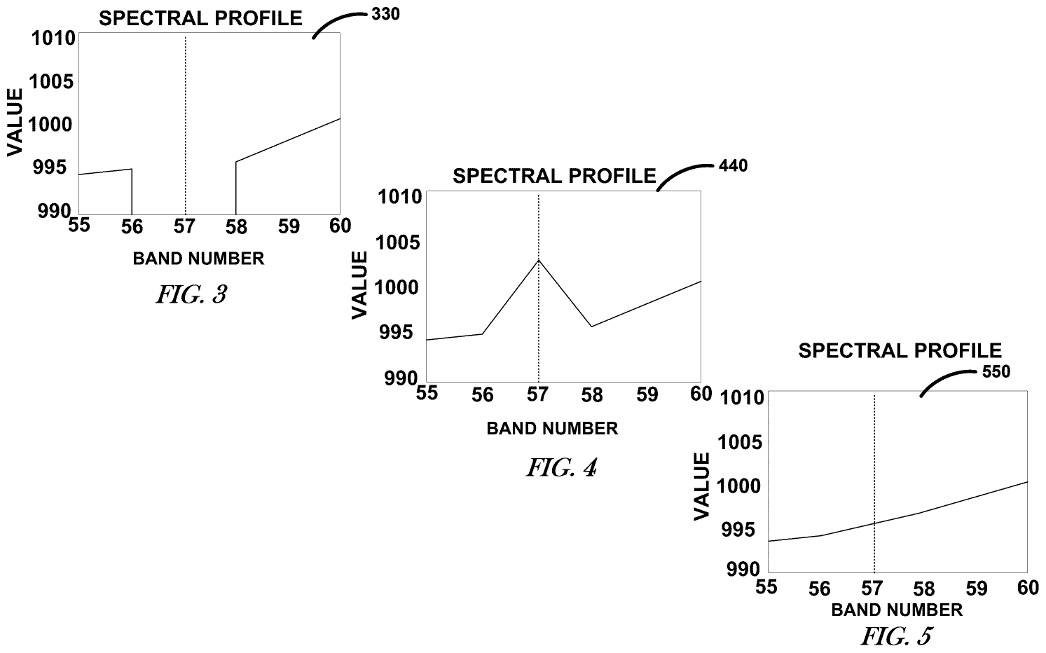

FIG. 3 illustrates, by way of example, a notional example of a spectral profile 330 generated by a failed detector. The spectral profile 330 is missing data for a frequency band, band “57” in the example of FIG. 3.

FIG. 4 illustrates, by way of example, a spectral profile 440 that is the result of using a 2D interpolation to fill in band “57 in the spectral profile 330. As can be seen, interpolation fills in the band “57” with a spike in magnitude. This is due to the pixel 222 corresponding to the failed detector being near an edge of an object. Thus, the interpolation is performed based on one or more pixels that are not the object.

FIG. 5 illustrates, by way of example, a spectral profile 550 that is the ground truth for the pixel. The spectral profile 440 generated using 2Dn interpolation is quite different than the spectral profile 550 that is ground truth in this example. Interpolation thus is not always as accurate as needed.

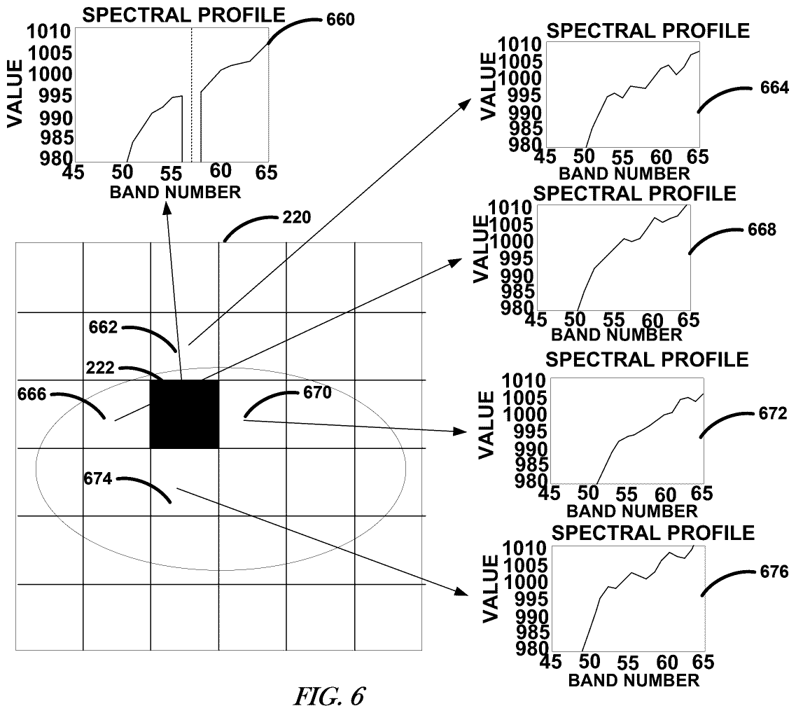

FIG. 6 illustrates, by way of example, a diagram of the notional hyperspectral image of FIG. 2 and a plurality of spectral profiles. The spectral profiles 660 corresponds to the pixel 222 that has a failed detector. The spectral profiles 664, 668, 672, 676 correspond to non-failed pixels 662, 666, 670, 674, respectively, that are in a neighborhood of the failed pixel 222. In executing the technique 100, a spectral profile that is most similar to the profile 660 is identified. In the example of FIG. 6, the spectral profile 672 is determined to be most similar to the spectral profile 660. Note that the most similar profile can be determined based on an entirety of the spectral profile or a subset of the bands in the spectral profile. In the example of FIG. 6, the most similar spectral profile is determined based on a proper subset of the spectral profile. The magnitude of the missing band data (band “57” in the example of FIG. 6) is then determined. The magnitude can be normalized based on magnitudes in the neighborhood of the band in the spectral profile with the failed detector and the spectral profile that is most similar. This is memorialized in Equation 1.

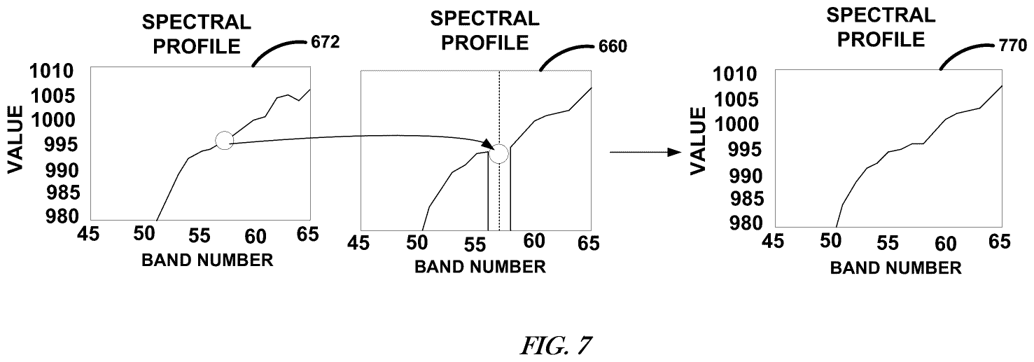

FIG. 7 illustrates, by way of example, altering of the spectral profile 660 corresponding to the failed detector to generate a spectral profile that is spectrally 770 consistent. One or more magnitudes and angles of the most similar spectral profile 672 are used to populate the missing band information of the spectral profile 660. The information from the spectral profile 672 is combined with information from the spectral profile 660 to determine the magnitude and angle for the band that is missing. The resulting spectral profile 770 is spectrally consistent such that downstream is unlikely to flag the information in the spectral profile as anomalous because of the failed detector. The information in the spectral profile that is anomalous will still be flagged as anomalous, unlike some techniques for determining the magnitude and angle for the failed detector.

During postprocessing of data collected by dispersive hyperspectral sensors, certain detectors on the focal plane (each representing a specific band and specific sample) are identified as “failed”. The failure can correspond to a “dead” detector or a high variance detector, but in either case, the radiance values from that detector are untrustworthy and can negatively impact downstream exploitation and analysis. To better support downstream analysts, the postprocessing workflow can replace the untrustworthy radiance with an educated guess. This process is called failed detector correction (FDC). Historically, FDC used interpolative methods for filling in these dead detectors, but these basic interpolative methods do not preserve the spectral angle and thus result in anomalies in downstream analysis algorithms that rely on an accurate spectral angle.

A dispersive hyperspectral system collects light and spreads the spectral bands across the focal plane in one direction and “samples” in the other direction. Each focal plane read collects a single “line”. By scanning the scene over time (multiple focal plane reads), a hyper-cube is formed.

During radiometric calibration, the hyperspectral imager is pointed at a “low” and a “high” uniform background for a period of time to collect hundreds of focal plane reads. Statistics are calculated for each detector. Detectors that are outliers (low variance, high variance, unusual gain, etc.) are considered failed detectors and a failed detector mask is formed.

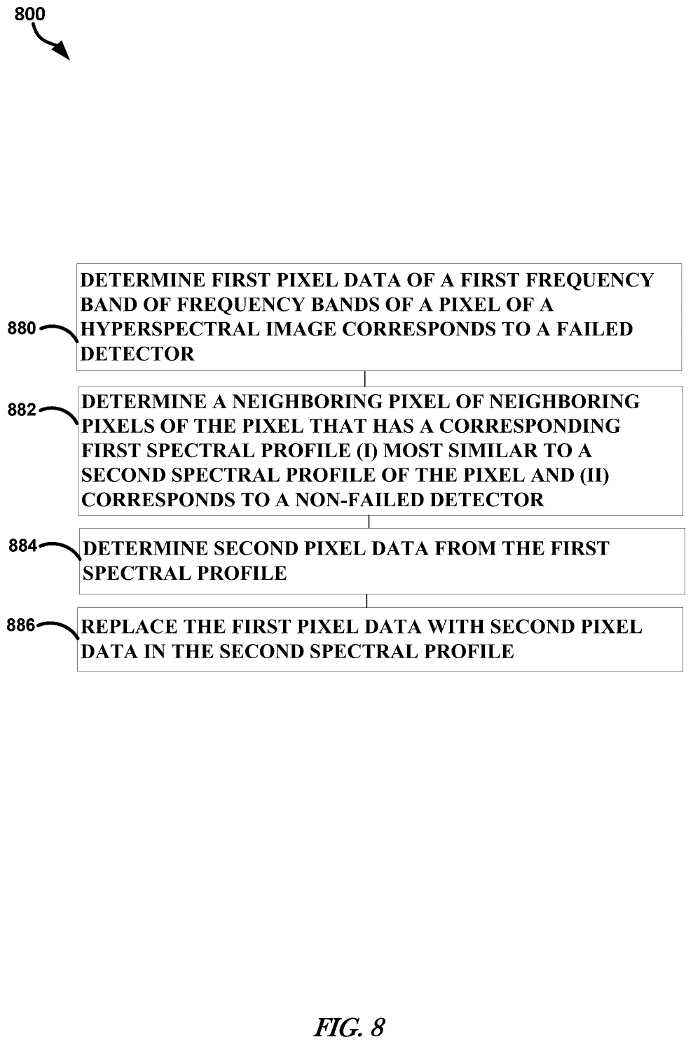

FIG. 8 illustrates, by way of example, a diagram of an embodiment of a method 800 for improved hyperspectral data recovery. The method 800 as illustrated includes determining first pixel data of a first frequency band of frequency bands of a pixel of a hyperspectral image corresponds to a failed detector, at operation 880; determining a neighboring pixel of neighboring pixels of the pixel that has a corresponding first spectral profile (i) most similar to a second spectral profile of the pixel and (ii) corresponds to a non-failed detector, at operation 882; determining second pixel data from the first spectral profile, at operation 884; and replacing the first pixel data with second pixel data in the second spectral profile, at operation 886.

Determining the neighboring pixel of the neighboring pixels that has the corresponding first spectral profile can include determining a similarity between respective vectors representing the first and second spectral profiles. The similarity can be determined as a dot product, cross product, a distance measure, or the like, between the respective vectors. The respective vectors can represent a proper subset of the first and second spectral profiles and include the first frequency band. Determining the second pixel data can include normalizing the second pixel data based on other pixel data from the first spectral profile. Normalizing the second pixel data can include determining a ratio of magnitudes of second frequency bands of (i) the second spectral profile and (ii) the first spectral profile. The second frequency bands can include the frequency bands nearest the first frequency band in the first and second spectral profiles that correspond to non-failed detectors. A magnitude of the first frequency band in the first spectral profile can be scaled by the ratio.

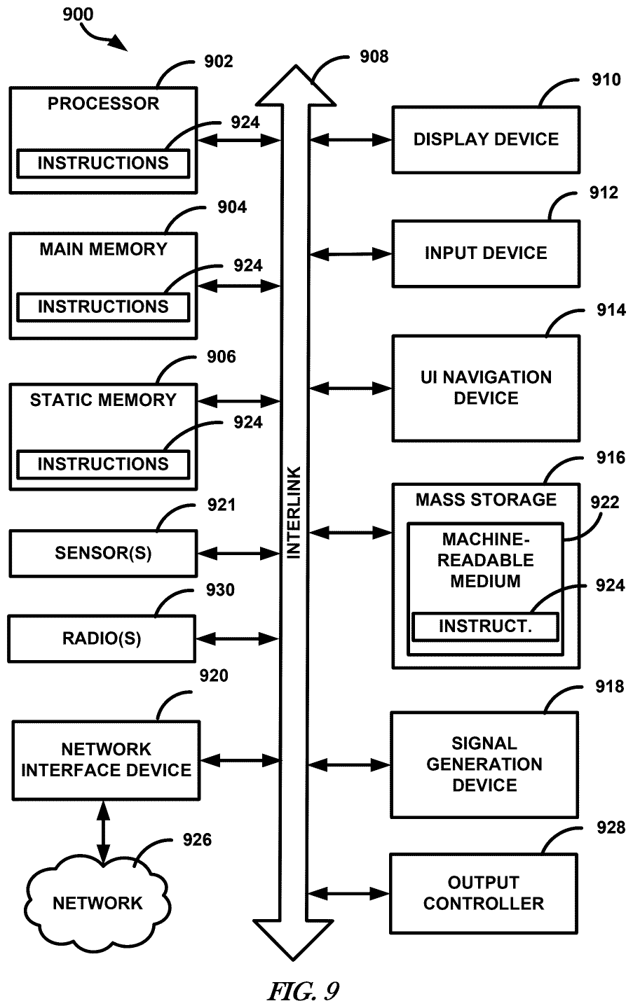

FIG. 9 illustrates, by way of example, a block diagram of an embodiment of a machine in the example form of a computer system 900 within which instructions for causing the machine to perform any one or more of the methods or techniques discussed herein may be executed. One or more of the operations 110, 112, 114, 116, method 800, or other component, operation, or technique, can include, or be implemented or performed by one or more of the components of the computer system 900. In a networked deployment, the machine may operate in the capacity of a server or a client machine in server-client network environment, or as a peer machine in a peer-to-peer (or distributed) network environment. The machine may be a personal computer (PC), server, a tablet PC, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a user interface (UI) navigation device 914 (e.g., a mouse), a mass storage unit 916, a signal generation device 918 (e.g., a speaker), a network interface device 920, and a radio 930 such as Bluetooth, WWAN, WLAN, and NFC, permitting the application of security controls on such protocols.

The mass storage unit 916 includes a machine-readable medium 922 on which is stored one or more sets of instructions and data structures (e.g., software) 924 embodying or utilized by any one or more of the methodologies or functions described herein. The instructions 924 may also reside, completely or at least partially, within the main memory 904 and/or within the processor 902 during execution thereof by the computer system 900, the main memory 904 and the processor 902 also constituting machine-readable media.

While the machine-readable medium 922 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding, or carrying instructions for execution by the machine and that cause the machine to perform any one or more of the methodologies of the present invention, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The instructions 924 may further be transmitted or received over a communications network 926 using a transmission medium. The instructions 924 may be transmitted using the network interface device 920 and any one of a number of well-known transfer protocols (e.g., HTTPS). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of encoding, or carrying instructions for execution by the machine, and includes digital or analog communications signals or other intangible media to facilitate communication of such software.

### Additional Examples

Example 1 includes a method comprising determining first pixel data of a first frequency band of frequency bands of a pixel of a hyperspectral image corresponds to a failed detector, determining a neighboring pixel of neighboring pixels of the pixel that has a corresponding first spectral profile (i) most similar to a second spectral profile of the pixel and (ii) corresponds to a non-failed detector, determining second pixel data from the first spectral profile, and replacing the first pixel data with second pixel data in the second spectral profile.

In Example 2, Example 1 further includes, wherein determining the neighboring pixel of the neighboring pixels that has the corresponding first spectral profile includes determining a similarity between respective vectors representing the first and second spectral profiles.

In Example 3, Example 2 further includes, wherein the respective vectors represent a proper subset of the first and second spectral profiles and include the first frequency band.

In Example 4, at least one of Examples 1-3 further includes, wherein determining the second pixel data includes normalizing the second pixel data based on other pixel data from the first spectral profile.

In Example 5, Example 4 further includes, wherein normalizing the second pixel data includes determining a ratio of magnitudes of second frequency bands of (i) the second spectral profile and (ii) the first spectral profile.

In Example 6, Example 5 further includes, wherein the second frequency bands are the frequency bands nearest the first frequency band in the first and second spectral profiles that correspond to non-failed detectors.

In Example 7, at least one of Examples 5-6 further includes, wherein a magnitude of the first frequency band in the first spectral profile is scaled by the ratio.

Example 8 includes a non-transitory machine-readable medium including instructions that, when executed by a machine, cause the machine to perform operations for improving failed detector correction (FDC), the operations comprising determining first pixel data of a first frequency band of frequency bands of a pixel of a hyperspectral image corresponds to a failed detector, determining a neighboring pixel of neighboring pixels of the pixel that has a corresponding first spectral profile (i) most similar to a second spectral profile of the pixel and (ii) corresponds to a non-failed detector, determining second pixel data from the first spectral profile, and replacing the first pixel data with second pixel data in the second spectral profile.

In Example 9, Example 8 further includes, wherein determining the neighboring pixel of the neighboring pixels that has the corresponding first spectral profile includes determining a similarity between respective vectors representing the first and second spectral profiles.

In Example 10, Example 9 further includes, wherein the respective vectors represent a proper subset of the first and second spectral profiles and include the first frequency band.

In Example 11, at least one of Examples 8-10 further includes, wherein determining the second pixel data includes normalizing the second pixel data based on other pixel data from the first spectral profile.

In Example 12, Example 11 further includes, wherein normalizing the second pixel data includes determining a ratio of magnitudes of second frequency bands of (i) the second spectral profile and (ii) the first spectral profile.

In Example 13, Example 12 further includes, wherein the second frequency bands are the frequency bands nearest the first frequency band in the first and second spectral profiles that correspond to non-failed detectors.

In Example 14, at least one of Examples 12-13 further includes, wherein a magnitude of the first frequency band in the first spectral profile is scaled by the ratio.

Example 15 includes a system comprising processing circuitry, and a memory including instructions that, when executed by the processing circuitry, cause the processing circuitry to perform operations for failed detector correction (FDC), the operations comprising determining first pixel data of a first frequency band of frequency bands of a pixel of a hyperspectral image corresponds to a failed detector, determining a neighboring pixel of neighboring pixels of the pixel that has a corresponding first spectral profile (i) most similar to a second spectral profile of the pixel and (ii) corresponds to a non-failed detector, determining second pixel data from the first spectral profile, and replacing the first pixel data with second pixel data in the second spectral profile.

In Example 16, Example 15 further includes, wherein determining the neighboring pixel of the neighboring pixels that has the corresponding first spectral profile includes determining a similarity between respective vectors representing the first and second spectral profiles.

In Example 17, Example 16 further includes, wherein the respective vectors represent a proper subset of the first and second spectral profiles and include the first frequency band.

In Example 18, at least one of Examples 15-17 further includes, wherein determining the second pixel data includes normalizing the second pixel data based on other pixel data from the first spectral profile.

In Example 19, Example 18 further includes, wherein normalizing the second pixel data includes determining a ratio of magnitudes of second frequency bands of (i) the second spectral profile and (ii) the first spectral profile.

In Example 20, Example 19 further includes, wherein the second frequency bands are the frequency bands nearest the first frequency band in the first and second spectral profiles that correspond to non-failed detectors.

Although teachings have been described with reference to specific example teachings, it will be evident that various modifications and changes may be made to these teachings without departing from the broader spirit and scope of the teachings. Accordingly, the specification and drawings are to be regarded in an illustrative rather than a restrictive sense. The accompanying drawings that form a part hereof, show by way of illustration, and not of limitation, specific teachings in which the subject matter may be practiced. The teachings illustrated are described in sufficient detail to enable those skilled in the art to practice the teachings disclosed herein. Other teachings may be utilized and derived therefrom, such that structural and logical substitutions and changes may be made without departing from the scope of this disclosure. This Detailed Description, therefore, is not to be taken in a limiting sense, and the scope of various teachings is defined only by the appended claims, along with the full range of equivalents to which such claims are entitled.

What is claimed is:

1. A method comprising:
determining first pixel data of a first frequency band of frequency bands of a pixel of a hyperspectral image corresponds to a failed detector;
determining a neighboring pixel of neighboring pixels of the pixel that has a corresponding first spectral profile (i) most similar to a second spectral profile of the pixel and (ii) corresponds to a non-failed detector;
determining second pixel data from the first spectral profile; and
replacing the first pixel data with second pixel data in the second spectral profile.

2. The method of claim 1, wherein determining the neighboring pixel of the neighboring pixels that has the corresponding first spectral profile includes determining a similarity between respective vectors representing the first and second spectral profiles.

3. The method of claim 2, wherein the respective vectors represent a proper subset of the first and second spectral profiles and include the first frequency band.

4. The method of claim 1, wherein determining the second pixel data includes normalizing the second pixel data based on other pixel data from the first spectral profile.

5. The method of claim 4, wherein normalizing the second pixel data includes determining a ratio of magnitudes of second frequency bands of (i) the second spectral profile and (ii) the first spectral profile.

6. The method of claim 5, wherein the second frequency bands are the frequency bands nearest the first frequency band in the first and second spectral profiles that correspond to non-failed detectors.

7. The method of claim 5, wherein a magnitude of the first frequency band in the first spectral profile is scaled by the ratio.

8. A non-transitory machine-readable medium including instructions that, when executed by a machine, cause the machine to perform operations for improving failed detector correction (FDC), the operations comprising:
determining first pixel data of a first frequency band of frequency bands of a pixel of a hyperspectral image corresponds to a failed detector;
determining a neighboring pixel of neighboring pixels of the pixel that has a corresponding first spectral profile (i) most similar to a second spectral profile of the pixel and (ii) corresponds to a non-failed detector;
determining second pixel data from the first spectral profile; and
replacing the first pixel data with second pixel data in the second spectral profile.

9. The non-transitory machine-readable medium of claim 8, wherein determining the neighboring pixel of the neighboring pixels that has the corresponding first spectral profile includes determining a similarity between respective vectors representing the first and second spectral profiles.

10. The non-transitory machine-readable medium of claim 9, wherein the respective vectors represent a proper subset of the first and second spectral profiles and include the first frequency band.

11. The non-transitory machine-readable medium of claim 8, wherein determining the second pixel data includes normalizing the second pixel data based on other pixel data from the first spectral profile.

12. The non-transitory machine-readable medium of claim 11, wherein normalizing the second pixel data includes determining a ratio of magnitudes of second frequency bands of (i) the second spectral profile and (ii) the first spectral profile.

13. The non-transitory machine-readable medium of claim 12, wherein the second frequency bands are the frequency bands nearest the first frequency band in the first and second spectral profiles that correspond to non-failed detectors.

14. The non-transitory machine-readable medium of claim 12, wherein a magnitude of the first frequency band in the first spectral profile is scaled by the ratio.

15. A system comprising:
processing circuitry; and
a memory including instructions that, when executed by the processing circuitry, cause the processing circuitry to perform operations for failed detector correction (FDC), the operations comprising:
determining first pixel data of a first frequency band of frequency bands of a pixel of a hyperspectral image corresponds to a failed detector;
determining a neighboring pixel of neighboring pixels of the pixel that has a corresponding first spectral profile (i) most similar to a second spectral profile of the pixel and (ii) corresponds to a non-failed detector;
determining second pixel data from the first spectral profile; and
replacing the first pixel data with second pixel data in the second spectral profile.

16. The system of claim 15, wherein determining the neighboring pixel of the neighboring pixels that has the corresponding first spectral profile includes determining a similarity between respective vectors representing the first and second spectral profiles.

17. The system of claim 16, wherein the respective vectors represent a proper subset of the first and second spectral profiles and include the first frequency band.

18. The system of claim 15, wherein determining the second pixel data includes normalizing the second pixel data based on other pixel data from the first spectral profile.

19. The system of claim 18, wherein normalizing the second pixel data includes determining a ratio of magnitudes of second frequency bands of (i) the second spectral profile and (ii) the first spectral profile.

20. The system of claim 19, wherein the second frequency bands are the frequency bands nearest the first frequency band in the first and second spectral profiles that correspond to non-failed detectors.
